(19) United States
(12) Patent Application Publication
(10) Pub. No.: US 2016/0182824 A1
(43) Pub. Date: Jun. 23, 2016

(54) CAMERA CONTROLLING METHOD AND CAMERA DEVICE THEREOF

(71) Applicant: VIVOTEK INC., New Taipei City (TW)

(72) Inventors: Yi-Chuan Chen, New Taipei City (TW); Wen-Yuan Li, New Taipei City (TW); Yi-Chih Chiu, New Taipei City (TW); Yi-Hsin Yeh, New Taipei City (TW)

(21) Appl. No.: 14/972,094

(22) Filed: Dec. 17, 2015

(30) Foreign Application Priority Data
Dec. 22, 2014 (TW) 103144833

(51) Int. Cl. H04N 5/232; H04N 5/247; H04N 5/235; H04N 5/225

(52) U.S. Cl. CPC H04N 5/23238; H04N 5/2256; H04N 5/247; H04N 5/2354

(57) ABSTRACT

A camera controlling method is applied to a camera device. The camera device includes a plurality of image capturing modules and a plurality of light sources. Each light source is disposed at a position corresponding to at least one image capturing module. The plurality of image capturing modules is disposed adjacent to each other for capturing images. The camera controlling method includes receiving the image captured by each image capturing module sequentially according to a receiving sequence and turning on the light source corresponding to the next image capturing module when receiving the image captured by each image capturing module.

### BACKGROUND OF THE INVENTION

1. Field of the Invention

The present invention relates to a camera controlling method and a camera device thereof, and more specifically, to a camera controlling method for sequentially turning on light sources during a signal processing unit makes images captured by a plurality of image capturing modules sequentially received by an image processing unit according to a receiving sequence and a camera device thereof.

2. Description of the Prior Art

In general, a camera device could utilize a plurality of image capturing modules (e.g. four surveillance cameras having a shooting field-of-view of 45°) to capture images and then combine the images into one single image having a wide angle field-of-view (e.g. 180°) for a panoramic view. When the camera device is operated in a dark environment (e.g. in the night), the camera device would turn on each light source (e.g. an infrared light emitting diode) corresponding to the image capturing modules for providing auxiliary light to the image capturing modules. However, the aforesaid design causes the high power consumption problem since the light source is still turned on when the light source does not need to provide auxiliary light to the corresponding image capturing module.

### SUMMARY OF THE INVENTION

The present invention provides a camera controlling method applied to a camera device. The camera device includes a plurality of image capturing modules and a plurality of light sources. Each light source is disposed at a position corresponding to at least one image capturing module. The plurality of image capturing modules is disposed adjacent to each other for capturing images. The camera controlling method includes receiving the image captured by each image capturing module sequentially according to a receiving sequence and turning on the light source corresponding to the next image capturing module when receiving the image captured by each image capturing module.

The present invention further provides a camera device. The camera device includes a plurality of image capturing modules, a plurality of light sources, and an image processing module. The plurality of image capturing modules is used for capturing images. Each light source is disposed at a position corresponding to at least one image capturing module. The image processing module is electrically connected to the plurality of image capturing modules and the plurality of light sources, for receiving the image captured by each image capturing module sequentially according to a receiving sequence, and is used for turning on the light source corresponding to the next image capturing module when receiving the image captured by each image capturing module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a camera device according to an embodiment of the present invention.

FIG. 2 is a functional block diagram of the camera device in FIG. 1.

FIG. 3 is a diagram of a camera device according to another embodiment of the present invention.

FIG. 4 is a flowchart of a camera controlling method according to an embodiment of the present invention.

### DETAILED DESCRIPTION

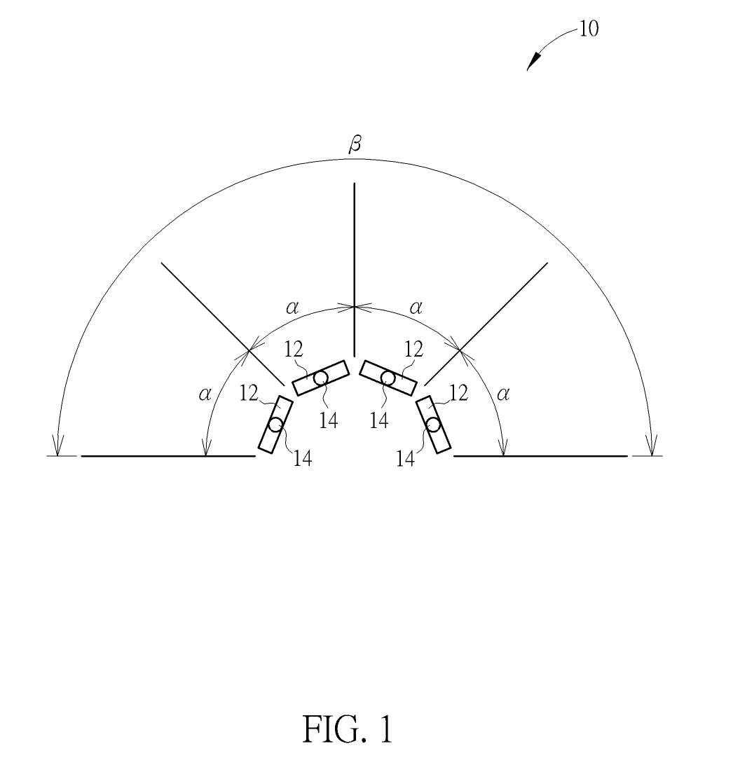

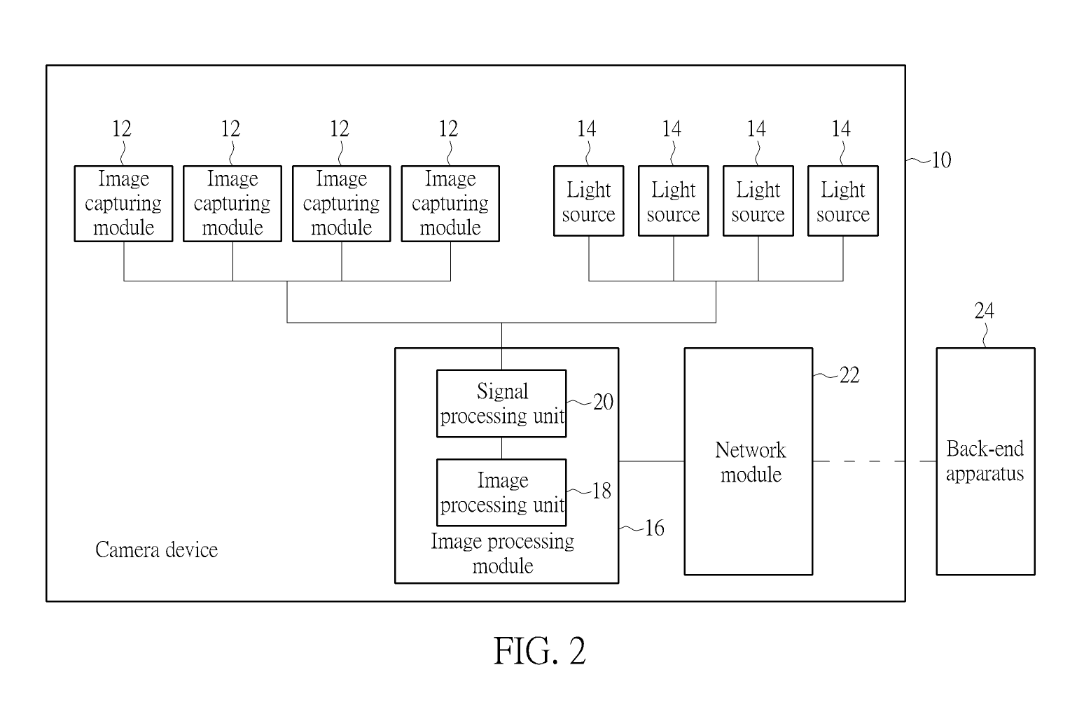

Please refer to FIG. 1 and FIG. 2. FIG. 1 is a diagram of a camera device 10 according to an embodiment of the present invention. FIG. 2 is a functional block diagram of the camera device 10 in FIG. 1. As shown in FIG. 1 and FIG. 2, the camera device 10 includes a plurality of image capturing modules 12 (taking four for example, but not limited thereto, meaning that the amount of the image capturing module depends on the practical application of the camera device 10), a plurality of light sources 14, and an image processing module 16. In practical application, the camera device 10 could further include a network module 22. The network module 22 is electrically connected to the image processing module 16 for transmitting images captured by the image capturing modules 12 to a back-end apparatus 24 (e.g. a remote storage device or a user computer) in a wired or wireless manner for image application.

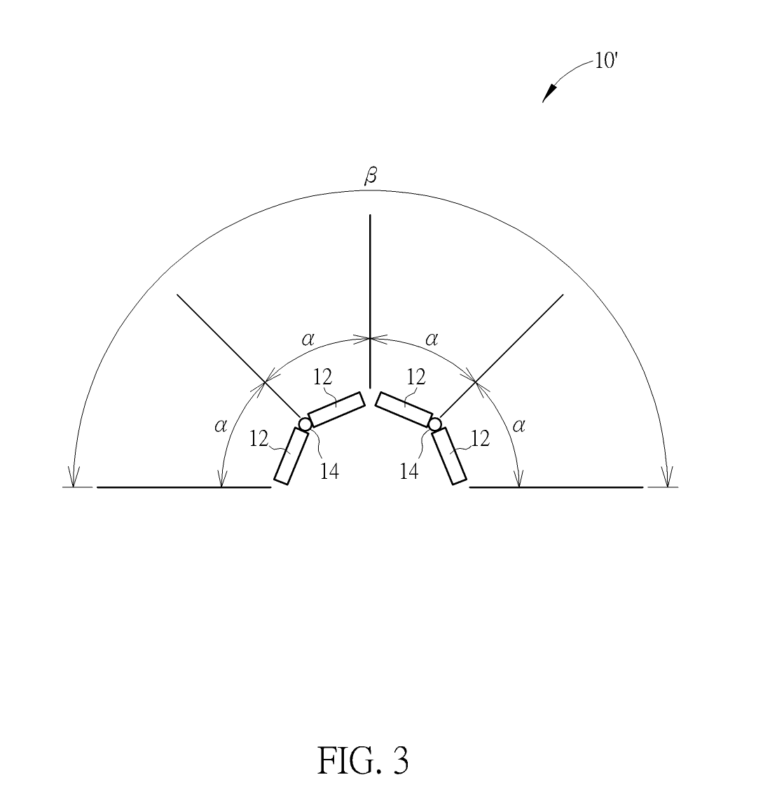

A light emitting range of each light source 14 is preferably identical to a field of view of the corresponding image capturing module 12, but not limited thereto. The amount of the light source 14 could vary according to the practical application of the camera device 10 and the light emitting range of the light source 14. In this embodiment, each light source 14 could be preferably an infrared light emitting diode (but not limited thereto) and could be arranged with the plurality of image capturing modules 12 in a one-to-one manner, but not limited thereto, meaning that the camera device 10 could also adopt the design that each light source 14 could be arranged with the plurality of image capturing modules 12 in a one-to-many manner for reducing the manufacturing cost of the camera device 10. For example, please refer to FIG. 3, which is a diagram of a camera device 10′ according to another embodiment of the present invention. The camera device 10′ could adopt the design that one light source 14 corresponds to two adjacent image capturing modules 12 and a light emitting range of this light source 14 could cover the image capturing ranges of the two adjacent image capturing modules 12.

The image processing module 16 is electrically connected to the image capturing modules 16 and the light sources 14. The image processing module 16 is used for receiving and processing the images captured by the image capturing modules 12, and is used for turning on or turning off the light sources 14. To be more specific, in this embodiment, the image processing module 16 could include an image processing unit 18 and a signal processing unit 20. The image processing unit 18 could be an SOC (System on Chip) to receive the images captured by the image capturing modules 12 for image processing, such as image stitching, image adjustment (e.g. white balance, color saturation, or color contrast), or image encoding. The signal processing unit 20 could be an FPGA (Field Programmable Gate Array) and is electrically connected to the image capturing modules 12, the light sources 14, and the image processing unit 18, for making the images captured by the image capturing modules 12 sequentially received by the image processing unit 18 according to a receiving sequence, for sequentially turning on or turning off the light sources 14 during the image processing unit 18 receives the images captured by the image capturing modules 12 sequentially, and for adjusting a frame rate of each image capturing module 12 so as to adjust an exposure time of each image capturing module 12 in this embodiment. Furthermore, the signal processing unit 20 could also be used for transforming a signal format (e.g. a serial signal) of the images transmitted from the image capturing modules 12 into a readable signal format (e.g. a parallel signal) for the image processing unit 18.

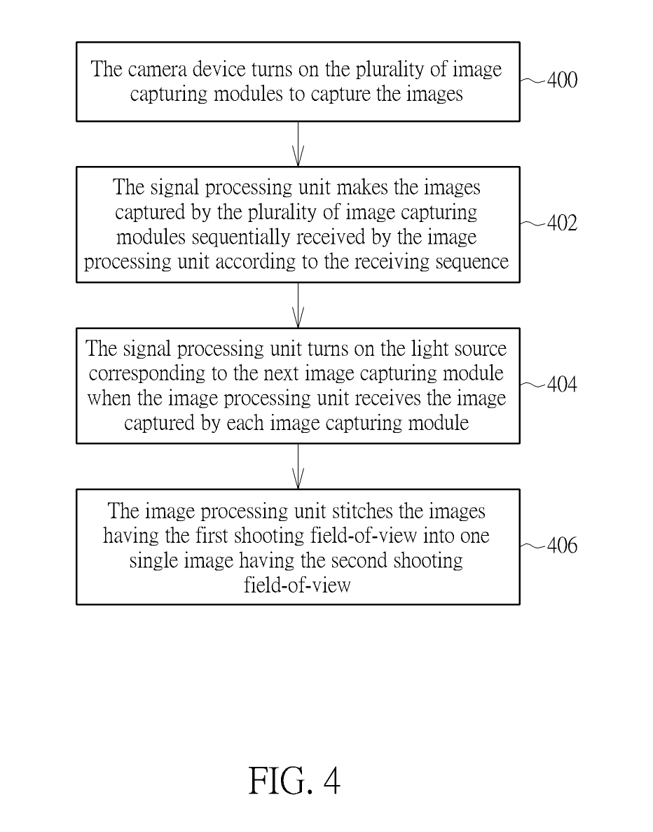

The camera controlling method of the camera device 10 is described herein. Please refer to FIG. 1, FIG. 2, and FIG. 4. FIG. 4 is a flow chart of a camera controlling method according to an embodiment of the present invention. The camera controlling method of the present invention includes the following steps.

Step 400: The camera device 10 turns on the plurality of image capturing modules 12 to capture the images.

Step 402: The signal processing unit 20 makes the images captured by the plurality of image capturing modules 12 sequentially received by the image processing unit 18 according to the receiving sequence.

Step 404: The signal processing unit 20 turns on the light source 14 corresponding to the next image capturing module 12 when the image processing unit 18 receives the image captured by each image capturing module 12.

Step 406: The image processing unit 18 stitches the images having a first shooting field-of-view α into one single image having a second shooting field-of-view δ.

More detailed description for the aforesaid steps is provided as follows. In Step 400, the camera device 10 could turn on the plurality of image capturing modules 12 for capturing the images. As shown in FIG. 1, each image capturing module 12 has the first shooting field-of-view α (the first shooting field-of-view α of each image capturing module 12 could be overlapped partially with the first shooting field-of-view α of the adjacent image capturing module 12, but not limited thereto). A light emitting range of each light source 14 could be preferably identical to the image capturing range of the corresponding image capturing module 12 for providing sufficient light, so as to ensure that the image capturing module 12 could capture the image with sufficient illumination. Subsequently, the signal processing unit 20 could make the images captured by the plurality of image capturing modules 12 sequentially received by the image processing unit 18 according to a receiving sequence (Step 402), which is predetermined by the camera device 10 or defined by a user. For example, the image processing unit 18 could receive the images according to a clockwise or counterclockwise receiving sequence. That is, in Step 404, if the signal processing unit 20 makes the images sequentially received by the image processing unit 18 according to a clockwise receiving sequence, the signal processing unit 20 could turn on the light source 14 (i.e. the light source 14 at the upper left side) corresponding to the next image capturing module 14 (i.e. the image capturing module 12 located at the upper left side and adjacent to the image capturing module 12 located at the leftmost side) during the image capturing module 12 at the leftmost side in FIG. 1 has completed the image capturing process and the captured image is received by the image processing unit 18 via the signal processing unit 20, so that the next image capturing module 12 could perform an image exposure process via light of the light source 14 at the upper left side. To be noted, during the aforesaid process, the signal processing unit 20 could further turn off the light source (i.e. the light source 14 located at the leftmost side) corresponding to the image capturing module 12 at the leftmost side in FIG. 1, so as to reduce the power consumption of the camera device 10.

After the image captured by the image capturing module 12 at the leftmost side is received by the image processing unit 18 via the signal processing unit 20 and the image capturing module 12 at the upper left side has completed the image capturing process, the signal processing unit 20 could make the image captured by the image capturing module 12 at the upper left side in FIG. 1 received by the image processing unit 18. During the aforesaid process, the signal processing unit 20 could turn on the light source 14 (i.e. the light source 14 at the upper right side) corresponding to the next image capturing module 14 (i.e. the image capturing module 12 located at the upper right side and adjacent to the image capturing module 12 located at the upper left side), so that the image capturing module 12 at the right upper side could simultaneously perform an image exposure process via light of the aforesaid light source 14 at the upper right side. Similarly, in practical application, the signal processing unit 20 could also turn off the light source 14 at the upper left side during the aforesaid process, so as to further reduce the power consumption of the camera device 10. As for the related description for the image receiving processes of the image capturing modules 12 at the upper right and rightmost sides and the controlling processes of the light sources 14 at the upper right and rightmost sides, it could be reasoned by analogy according to the aforesaid description and omitted herein.

In practical application, after the image processing unit 18 sequentially receives the images captured by the image capturing modules 12 at the leftmost, upper left, upper right, and rightmost sides, as shown in FIG. 1, the image processing unit 18 could stitch the plurality of received images having the first shooting field-of-view α into one single image having the second shooting field-of-view β (Step 406), so that the user could view the image having a wide angle field-of-view. For example, if the first shooting field-of-view α is equal to 45°, the camera device 10 could generate the image having the second shooting field-of-view β of 180° after sequentially receiving the images captured by the image capturing modules 12 at the leftmost, upper left, upper right, and rightmost sides. In such a manner, after repeating the aforesaid process, the camera device 10 could generate panoramic-view images having the second shooting field-of-view β for achieving the panoramic surveillance purpose.

In summary, via the design that the signal processing unit 20 sequentially turns on the light sources during the signal processing unit 20 makes the images captured by the plurality of image capturing modules 12 sequentially received by the image processing unit 18 according to the receiving sequence, the camera device 10 of the present invention could efficiently solve the prior art problem that the light source is still turned on when the light source does not need to provide auxiliary light to the corresponding image capturing module, so as to greatly reduce the power consumption of the camera device 10.

It should be mentioned that the camera device 10 could further turn on the light sources 14 corresponding to at least two image capturing modules 12 if the time that the image processing unit 18 receives the image captured by one image capturing module 12 is not enough to make the next image capturing module 12 complete the image capturing process. Accordingly, the camera device 10 could ensure that each image capturing module 12 could complete the image capturing process before the captured image is received by the image processing unit 18 according to the aforesaid receiving sequence.

For example, in another embodiment, assuming that the image capturing module 12 at the upper right side (the related description for the other image capturing modules 12 could be reasoned by analogy according to the following description) could only have completed the image capturing process after the image processing unit 18 performs the image receiving process twice, the signal processing unit 20 could turn on the light source 14 (i.e. the light source 14 at the upper left side) corresponding to the next image capturing module 12 (i.e. the image capturing module 12 at the upper left side) and turn on the light source 14 (i.e. the light source 14 at the upper right side) corresponding to the image capturing module 12 after next (i.e. the image capturing module 12 at the upper right side) during the image capturing module 12 at the leftmost side has completed the image capturing process and the captured image is received by the image processing unit 18 via the signal processing unit 20. Subsequently, during the image capturing module 12 at the upper left side has completed the image capturing process and the captured image is received by the image processing unit 18 via the signal processing unit 20, the signal processing unit 20 could still turn on the light source 14 (i.e. the light source 14 at the upper right side) corresponding to the next image capturing module 12 (i.e. the image capturing module 12 at the upper right side) and turn on the light source 14 (i.e. the light source 14 at the rightmost side) corresponding to the image capturing module 12 after next (i.e. the image capturing module 12 at the rightmost side). In such a manner, as mentioned above, since the signal processing unit 20 keeps the light source 14 at the upper right side turned on during the images captured by the image capturing modules 12 at the leftmost and upper left sides are received by the image processing unit 18 via the signal processing unit 20 respectively, the image capturing module 12 at the upper right side could surely complete the image exposure process by utilizing light of the light source 14 at the upper right side, so as to achieve the purpose that the image capturing module 12 at the upper right side has completed the image capturing process before the captured image is received by the image processing unit 18.

Furthermore, the camera device 10 could selectively turn on at least two adjacent image capturing modules 12 for adjusting the second shooting field-of-view β. For example, the camera device 10 could only turn on the image capturing modules 12 at the upper left and upper right sides. Accordingly, after the image processing unit 18 receives the images captured by the image capturing modules 12 at the upper left and upper right sides, the image processing unit 18 could stitch the two images having the first shooting field-of-view α (e.g. 45°) into one single image having the second shooting field-of-view β (e.g. 45°+45°=90°), so as to achieve the purpose that the present invention could flexibly adjust the shooting field-of-view of the captured image according to the practical application of the camera device 10.

Moreover, when the camera device 10 is operated in a bright environment (e.g. in the daytime), the signal processing unit 20 does not need to turn on the light sources 14, meaning that the camera device 10 just needs to turn on the plurality of image capturing modules 12 to capture images without executing Step 404. Subsequently, the image processing unit 18 stitches the images having the first field-of-view α into one single image having the second shooting field-of-view β after the signal processing unit 20 makes the images captured by the plurality of image capturing modules 12 sequentially received by the image processing unit 18 according to the receiving sequence, so that the user could view the image of a wide angle field-of-view.

Compared with the prior art, the present invention adopts the design that the signal processing unit turns on the light sources sequentially during the image processing unit sequentially receives the images captured by the plurality of image capturing modules according to the receiving sequence via the signal processing unit, for efficiently solving the prior art problem that the light source is still turned on when the light source does not need to provide auxiliary light to the corresponding image capturing module. In such a manner, the present invention could greatly reduce the power consumption of the camera device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera controlling method applied to a camera device, the camera device comprising a plurality of image capturing modules and a plurality of light sources, each light source being disposed at a position corresponding to at least one image capturing module, the plurality of image capturing modules being disposed adjacent to each other for capturing images, the camera controlling method comprising:
receiving the image captured by each image capturing module sequentially according to a receiving sequence; and
turning on the light source corresponding to the next image capturing module when receiving the image captured by each image capturing module.

2. The camera controlling method of claim 1, wherein the plurality of image capturing modules and the plurality of light sources are arranged in a one-to-one or many-to-one manner.

3. The camera controlling method of claim 1, wherein each image capturing module has a first shooting field-of-view, and the first shooting field-of-view of each image capturing module is overlapped partially with the first shooting field-of-view of the adjacent image capturing module, the camera device combines each first shooting field-of-view into a second shooting field-of-view of the camera device, and the second shooting field-of-view is greater than the first shooting field-of-view.

4. The camera controlling method of claim 3, wherein the number of the plurality of image capturing modules is equal to N, the camera device receives the images captured by the adjacent M image capturing devices according to the receiving sequence for controlling the second shooting field-of-view of the camera device, N is greater than or equal to M, and N and M are positive integers.

5. The camera controlling method of claim 3 further comprising:
stitching the images having the first shooting field-of-view into one single image having the second shooting field-of-view.

6. The camera controlling method of claim 1, wherein a light emitting range of each light source is substantially identical to a field of view of the corresponding at least one image capturing module.

7. The camera controlling method of claim 1 further comprising:
turning on the light source corresponding to the image capturing module after next when receiving the image captured by each image capturing module.

8. The camera controlling method of claim 1 further comprising:
when receiving the image captured by one of the plurality of image capturing modules, turning off the light source corresponding to the one of the plurality of image capturing modules.

9. A camera device comprising:
a plurality of image capturing modules for capturing images;
a plurality of light sources, each light source being disposed at a position corresponding to at least one image capturing module; and
an image processing module electrically connected to the plurality of image capturing modules and the plurality of light sources, for receiving the image captured by each image capturing module sequentially according to a receiving sequence and for turning on the light source corresponding to the next image capturing module when receiving the image captured by each image capturing module.

10. The camera device of claim 9, wherein the plurality of image capturing modules and the plurality of light sources are arranged in a one-to-one or many-to-one manner.

11. The camera device of claim 9, wherein each image capturing module has a first shooting field-of-view, and the first shooting field-of-view of each image capturing module is overlapped partially with the first shooting field-of-view of the adjacent image capturing module, the image processing module combines each first shooting field-of-view into a second shooting field-of-view of the camera device, and the second shooting field-of-view is greater than the first shooting field-of-view.

12. The camera device of claim 11, wherein the number of the plurality of image capturing modules is equal to N, the image processing module receives the images captured by the adjacent M image capturing devices according to the receiving sequence for controlling the second shooting field-of-view of the camera device, N is greater than or equal to M, and N and M are positive integers.

13. The camera device of claim 11, wherein the image processing module is further used for stitching the images having the first shooting field-of-view into one single image having the second shooting field-of-view.

14. The camera device of claim 9, wherein a light emitting range of each light source is substantially identical to a field of view of the corresponding at least one image capturing module.

15. The camera device of claim 9, wherein the image processing module is further used for turning on the light source corresponding to the image capturing module after next when receiving the image captured by each image capturing module.

16. The camera device of claim 9, wherein the image processing module is further used for turning off the light source corresponding to one of the plurality of image capturing modules when receiving the image captured by the one of the plurality of image capturing modules.

17. The camera device of claim 9, wherein the image processing module comprises:
an image processing unit for receiving the images transmitted from the plurality of image capturing modules to process the images; and
a signal processing unit electrically connected to the plurality of image capturing modules, the plurality of light sources and the image processing unit, for making the image captured by each image capturing module sequentially received by the image processing unit according to the receiving sequence and for turning on or turning off the plurality of light sources.
